(19) United States
(12) Patent Application Publication
(10) Pub. No.: US 2006/0190268 A1
(43) Pub. Date: Aug. 24, 2006

(54) Distributed language processing system and method of outputting intermediary signal thereof

(76) Inventor: Jui-Chang Wang, Taipei City (TW)

Correspondence Address: J.C. Patents, Inc., Suite 250, 4 Venture, Irvine, CA, 92618, US

(21) Appl. No.: 11/302,029

(22) Filed: Dec. 12, 2005

(30) Foreign Application Priority Data
Feb. 18, 2005 (TW) 94104792

(51) Int. Cl. G10L 21/00

(52) U.S. Cl. 704/275

(57) ABSTRACT

A unified speech input dialogue interface, and a distributed multiple application-dependent language processing unit system with the unified speech recognition function and the unified dialogue interface are provided. The system not only provides a convenient user's environment, but also enhances the whole performance of speech recognition. The distributed multiple application-dependent language processing unit system uses a speech input interface so that the user can be familiar with a simple, unified interface. The system also improves the speech recognition accuracy and enhances the convenience of use by self-learning personalized dialogue model.

### CROSS-REFERENCE TO RELATED APPLICATION

This application claims the priority benefit of Taiwan application serial no. 94104792, filed on Feb. 18, 2005. All disclosure of the Taiwan application is incorporated herein by reference.

### BACKGROUND OF THE INVENTION

1. Field of the Invention

The present invention relates to a distributed language processing system and a method of outputting an intermediary signal thereof, and more particularly to a distributed language processing system and a method of outputting an intermediary signal thereof, wherein the system uses a unified speech input interface so that a user can be familiar with the simple unified interface, enhances the user's speech recognition accuracy, and improves the system convenience by learning personal dialogue models.

2. Description of the Related Art

The human-machine interface technology by using speech input becomes more mature. As a result, more and more speech interfaces are required. The increase of the interfaces troubles users. A unified speech interface which provides connections among different application systems is a very convenient and necessary design for users.

By using the maturity of the human-machine technology with the speech input, the technology serves as the speech command control interface of an application system. The technology provides speech recognition through the phone, the automatic information search through the dialogue with a machine or automatic reservations etc. Speech command control function is similar to the remote control function. Since people have got used to communication through dialogue, an automatic speech dialogue system assists personal services for 24 hours a day, seven days a week. The system will not be shut down during midnight. The automatic speech system serves the routine works and provides excellent services that can be provided by human being. In addition, because of human nature in verbal communication, the automatic speech dialogue system is a great assistant providing personal services, such as the around-the-clock service for 7 days a week without any interruption. The system has gradually replaced the tedious routine work. Accordingly, the service quality that a staff can offer is thus improved.

Currently, most of the developed or developing speech technology is not matured. Accordingly, it has not been considered the convenience of using multiple speech technology products at the same time. For example, these interfaces have different operations, and take substantial calculation and memory resources. As a result, users must pay for the expensive services and systems individually and behave differently according to each individual man-machine interface design.

Generally, based on the vocabulary size of the speech input system, there are speech command control functions with small vocabulary and speech dialogue functions with medium or large vocabulary. There are local client software and the remote server systems. Various application softwares have different speech user interfaces which do not communicate with each other. Each speech dialogue system corresponds to only one application device. While many application systems are used, different speech user interfaces should be treated as different assistants at the same time. Such situation is inconvenient as a user simultaneously uses several remote controllers. The traditional structure is shown in FIG. 1.

Referring to FIG. 1, the structure comprises a microphone/speaker 110 to receive the input speech signal from the user. The signal is then transformed into a digital speech signal and transmitted to the server systems 112, 114 and 116 with the application program as shown in this figure. Each server system includes the application program user interface, the speech recognition function, the language understanding function and the dialogue-management function. If the user inputs commands through the phone, the analog speech signal is transmitted from the phone 120 through the phone interface cards 130, 140 and 150, and to the server system 132, 142, and 152, respectively. Each server system includes the application program user interface, the speech recognition function, the language understanding function and the dialogue-management function. Various application softwares have different speech user interfaces which do not communicate with each other. Each speech dialogue system corresponds to only one application device. While many application systems are used, different speech user interfaces should be turned on and work along without knowledge from each other. Such operation is very complicate and inconvenient.

For example, most of the speech dialogue systems through the phone lines use remote server systems, such as airline reservations or hospital reservations via natural language. The speech signals or the speech parameters are collected at the local terminal and transmitted to the remote terminal through the phone line. The remote speech recognition and language understanding processing unit translates the speech signals into semantic signals. Through the dialogue-control unit and the application processing unit of the application system, the communication or the commands inputted by the users is done. Generally, the speech recognition and language understanding processing unit is disposed at the remote server system and processed by the speaker-independent model as shown in FIG. 2.

Referring to FIG. 2, the user uses the phone as the input interface. The phone 210 transmits the analog speech signals, through the phone network and the phone interface card 220, to the server system 230. The server system 230 comprises the speech recognition unit 232, the language understanding unit 234, the dialogue-management unit 236 and the connected database server 240. The server system 230 generates and transmits a speech 238 to the user through the phone interface card 220.

Obviously, there are disadvantages in this structure, and yet to overcome the problem is difficult. First, use of different speech user interfaces at the same time results in confusion. Second, since lacking combination of a unified interface with the original application environment, installation of added or reduced application software(s) will be troublesome. Regarding the sound signal routes and model comparison calculations, how to prevent fighting for resources between the interfaces is another issue for operation. Third, independent acoustic comparison engine and model parameters do not support each other and cannot share their resources. For example, in the prior art technology the acoustic signals and accumulated custom of the user cannot be collected; the adjustment technology cannot be used to enhance the user-dependent acoustic model parameters, the language model parameters and application favor parameters. Generally, the speech recognition accuracy after adjustment is far better than that of the speaker-independent baseline system.

Accordingly, a unified speech user interface not only provides a more convenient user's environment, but also enhances the whole performance of speech recognition.

### SUMMARY OF THE INVENTION

Accordingly, the present invention provides a unified speech input dialogue interface and a distributed multiple application-dependent language processing unit system with a unified speech recognition function and a unified dialogue interface. The system not only provides convenient environment, but also enhances the whole performance of speech recognition.

The present invention provides a distributed multiple application-dependent language processing unit system. By using the unified speech input interface, a user can be more familiar with the simple unified interface, and the speech recognition accuracy of the user can also be improved. In addition, the system also learns the personal dialogue model and thus the convenience of using the system is further enhanced.

In order to achieve the object described above, the present invention provides a distributed language processing system which comprises a speech input interface, a speech recognition interface, a language processing unit, and a dialogue-management unit. The speech input interface receives a speech signal. The speech recognition interface, according to the speech signal received, recognizes and then generates a speech recognition result. The language processing unit receives and analyzes the speech recognition result to generate a semantic signal. The dialogue-management unit receives and determines the semantic signal, and then generates a semantic information corresponding to the speech signal.

In the distributed language processing system, the speech recognition interface comprises a model adaptation function so that a sound model recognizes the speech signal through the model adaptation function. In the model adaptation function, the sound model, which is speaker-dependent and device-dependent, refers to a common model, which is speaker-independent and device-independent as an initial model parameter to adjust a parameter of the sound model so that recognition result is optimized.

In the distributed language processing system, in an embodiment, the system further comprises a mapping unit between the speech recognition interface and the language processing unit to receive and map the speech recognition result; according to an output intermediary signal protocol, to generate and transmit a mapping signal serving as the speech recognition result to the language processing unit. The method of transmitting the mapping signal to the language processing unit comprises a broadcast method, a method through a cable communication network or a method through a wireless communication network. In the output intermediary signal protocol described above, the mapping signal is formed by a plurality of word units and a plurality of sub-word units. The sub-word comprises a Chinese syllable, an English phoneme, a plurality of English phonemes, or an English syllable.

According to the output intermediary signal protocol described above, the mapping signal is a sequence or a lattice composed of a plurality word units and a plurality of sub-word units.

In the distributed language processing system, the dialogue-management unit generates semantic information corresponding to the speech signal. If the semantic information corresponding to the speech signal generated from the dialogue-management unit is a speech command, an action corresponding to the speech command is performed. In an embodiment, when the speech command is larger than a confidence index, the action corresponding to the speech command will be performed.

In the distributed language processing system, the language processing unit comprises a language understanding unit and a database. The language understanding unit receives and then analyzes the speech recognition result, and refers to the database to obtain the semantic signal corresponding to the speech recognition result.

In the distributed language processing system, in an embodiment the system is structured according to a distributed architecture. In the distributed architecture, the speech input interface, the speech recognition interface and the dialogue-management unit are at a user terminal; and the language processing unit is at a system application server terminal.

Each system application server terminal comprises a language processing unit corresponding thereto. These language processing units receive and analyze the speech recognition results to obtain and transmit the semantic signals to the dialogue-management unit; according to determination of the semantic signals, semantic information corresponding to the semantic signals is generated. According to the distributed language processing system, in an embodiment, the speech input interface, the speech recognition interface, the language processing unit and the dialogue-management unit could be at a user terminal in a stand-alone system.

According to the distributed language processing system, in an embodiment, the speech recognition interface enhances recognition efficiency by learning according to the user's dialogue custom. Furthermore, the speech input interface comprises a greeting control mechanism, and greetings of the speech input interface can be changed by a user.

The present invention also provides a method of outputting an intermediary signal and a protocol used in the method. The method is adapted for a distributed language processing system. Wherein, the distributed language processing system is structured with a distributed architecture. The distributed architecture comprises a user terminal and a system application server terminal. The user terminal comprises a speech recognition interface and a dialogue-management unit. The system application server terminal comprises a language processing unit. In this method of outputting the intermediary signal, the speech recognition interface receives and analyzes a speech signal to generate a speech recognition result. The speech recognition result is transformed into a signal formed by a plurality of word units and a plurality of sub-word units according to the output intermediary signal protocol. The signal is then transmitted to the language processing unit for analyzing to obtain a semantic information. The semantic information is transmitted to the dialogue-management unit to generate a response to the user by graphical interface or voice interface.

In the method of outputting the intermediary signal and a protocol used in the method, the sub-word comprises a Chinese syllable, an English phoneme, a plurality of English phonemes or an English syllable. The signal composed of the plural words and sub-word units transformed in accordance with the intermediary signal protocol is a sequence or a lattice composed of a plurality word units and a plurality of sub-word units.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a drawing showing a prior art speech input system.

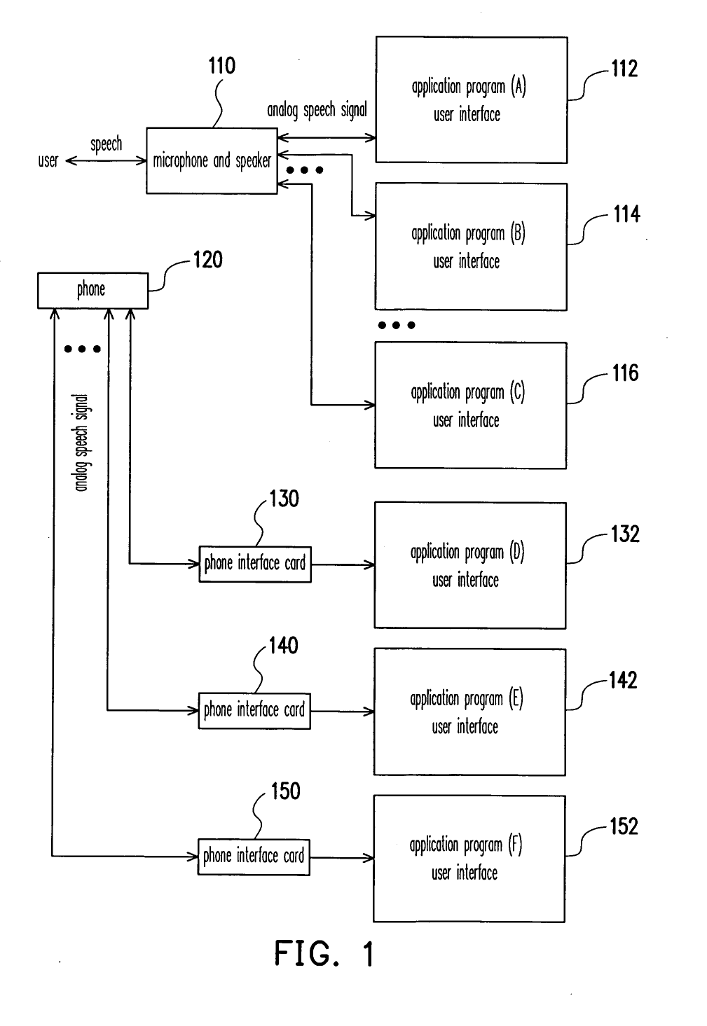

FIG. 2 is a block diagram showing a speech recognition and language analysis processing circuit of a traditional speech input system.

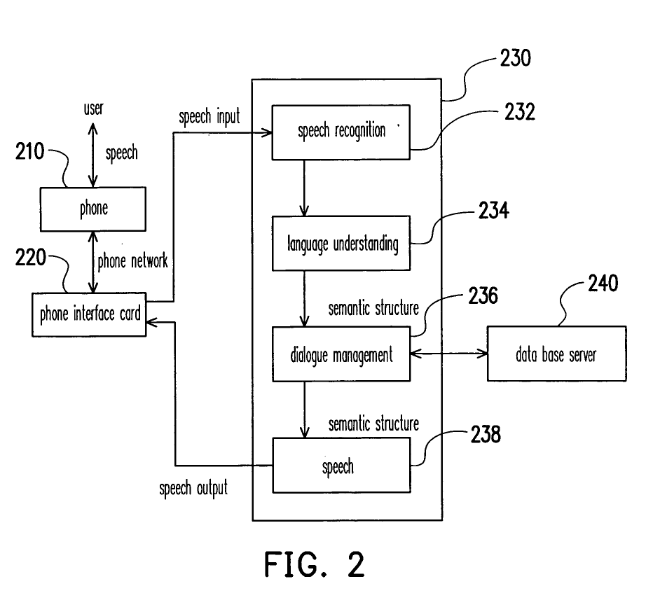

FIG. 3 is a drawing showing a distributed multiple application-dependent language processing unit system architecture with a unified speech recognition function, and a unified dialogue interface according to an embodiment of the present invention.

### DESCRIPTION OF SOME EMBODIMENTS

The present invention provides a unified speech input dialogue interface and a distributed multiple application-dependent language processing unit system with the unified speech recognition function and the unified dialogue interface. The system not only provides convenient environment, but also enhances the whole performance of speech recognition.

The human-machine interface technology using speech input becomes mature. In order to control different application apparatus, to search different information or to make reservations, various input interfaces may be required. If these interfaces have different operations, and if each of them takes a substantial calculation and memory resource, that will disturb a user. Accordingly, a simple interface with simple operation and connections to different application systems to provide a unified user's environment becomes very important for development and commercialization of advance speech technology. Since these interfaces use different operational modes and each occupies substantial calculations and memories, a user will be disturbed by the complicated and inconvenient applications. Accordingly, a simplified and easy-to-operate interface linking to different application systems to provide a unified user's environment is essential, particularly to the advanced speech technology development and popularity.

In order to solve the issue described above, in the present invention, a unified speech input interface is provided so that a user can be familiar with the unified interface; the speech recognition accuracy of the use is enhanced; the system also learns the personal dialogue model, and thus the convenience of using the system is also improved.

First, the sound model which is speaker-dependent and device-dependent is disposed at a local-terminal device. This structure provides the user a better acoustic comparison quality. In an embodiment, the sound model may use a common model which is speaker-independent and device-independent as an initial model to gradually improve the model parameters which are speaker-dependent and device-dependent by the model adaptation technology. The recognition accuracy is thus substantially improved. In an embodiment, a lexicon which is closely related to the speech recognition and an N-gram model which is language-dependent can be used in the model adaptation technology to improve the recognition quality.

The mentioned lexicon provides characters and information of sound units corresponding thereto to the speech recognition engine. For example, the word “recognition” in Chinese syllable units is /bian4/ /ren4/, or the phoneme units /b/, /i4/, /e4/, /M/, /r/, /e4/ and /M/. According to the information, the speech recognition engine composes the sound comparison model, such as the Hidden Markov Model (HMM).

The N-gram model described records the odds of connection of different characters, such as the odds of connections between “Republic of” and “China”, between “People of” and “Republic of”, and between “Republic of” and other characters. It also presents the possibility of connection between different characters. Since the function is similar to grammatical function, it is named with “-gram”. In a stricter definition: a model indicates frequency of N letters/words being connected. For example, in addition to practicing the pronunciation of Chinese characters/words, a non-Chinese should read more articles to learn the connections among these characters. The N-gram model also estimates the odds of the connections of different characters/words by sampling tremendous amount of articles.

With the output intermediary signal protocol of the speech recognition device, the front-end speech recognition result can be accepted by the back-end processing unit so that the meaning of the words can be accurately maintained. In different application devices, different groups of words are used. If a group of words is used as a unit, new recognizable word groups will be created continuously by the increase of the application programs. It will not be too much troublesome if there are only a few application systems. If many application systems are used, the great amount of the word-groups will seriously delay the front-end speech recognition unit. Accordingly, the shared intermediary signals include the shared common words and the shared sub-words. The common words may include frequently used speech commands. The addition of the common words enhances the recognition accuracy, and substantially reduces recognition confusion. The sub-words mentioned above are fragments smaller than a unit of words, such as a Chinese syllable, an English phoneme, multiple English phonemes or an English syllable.

The syllable described above is a Chinese phonetic unit. There are around 1,300 tonal syllables, or about 408 toneless syllables. Each Chinese character is a single syllable. In other words, each syllable represents the pronunciation of a character. In an article, the number of syllables represents the number of characters. For example, the Chinese character [symbol] shown by the tonal syllable of the Hanyu Pinyin system is /guo2/, and the Chinese character [symbol] is /jial/; or /guo/ and /jia/ are the toneless syllable.

In the above described English phoneme, multiple English phonemes or English syllable are used in English in which most of phonetics of an English word is multi-syllable. When the automatic speech recognizer is used to recognize English, appropriate amount of sound common units which are smaller than the multi-syllables should be provided in advance to serve as the model comparison units. They should include single syllable units or sub-syllable units. The most frequently used phoneme units in English phonological teaching comprise for example: /a/, /i/, /u/, /e/ and /o/ etc.

The output of the front-end speech recognition can be a sequence composed of N-Best common words and sub-words. In another embodiment, it can be a lattice of a common unit. While a user speaks a sentence (utters some words), the speech recognizer compares the sound to generate a recognition result with the highest comparison score. Since the recognition accuracy is not 100%, the output of the recognition result may include different possible recognition results. The output form with N strings of word sequence results are called the N-Best recognition result. Each string of word sequence results is an independent word string.

Another possible output form is lattice, which means the word lattice form that the common words of different word strings form a node. Different sentences are coupled to the common Chinese words so that all possible sentences are shown in a lattice as follows:

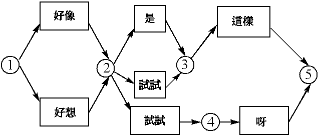

Node 1 represents the Start_Node.
Node 5 represents the End_Node.
Node 1 2 “ [symbol] ” represents Score (1, 2, “ [symbol] ”).
Node 1 2 “ [symbol] ” represents Score (1, 2, “ [symbol] ”).
Node 2 3 “ [symbol] ” represents Score (2, 3, “ [symbol] ”).
Node 2 3 “ [symbol] ” represents Score (2, 3, “ [symbol] ”).
Node 3 5 “ [symbol] ” represents Score (3, 5, “ [symbol] ”).
Node 4 5 “ [symbol] ” represents Score (4, 5, “ [symbol] ”).

The sequence or lattice described above is then broadcasted out, or sent out through a cable communication network or a wireless communication network. It is received by different application analysis devices. It can also be transmitted to the language processing analysis device to analyze the semantic content of the sequence or lattice without through a network. Each language processing analysis device individually analyzes and processes the sequence or lattice to obtain the corresponding semantic contents. These language understanding processing units correspond to different application systems individually. Therefore, they include different lexica and grammars. These language understanding processing steps screen out unrecognizable intermediary signals (including some common words and sub-words) and maintain recognizable signals so as to further analyze the sentence structures and perform the grammar comparison. Then the best and most reliable semantic signal is outputted and transmitted to the speech input interface apparatus of the user's local terminal.

The dialogue-management unit of the speech input interface apparatus collects all transmitted semantic signals. By adding the linguistic context of the semantic signals, the optimized result can be obtained. Multiple modalities would be then used to respond to the user to complete a dialogue during the conversation. If it is determined as a speech command, and if the confidence index is sufficient, the subsequent action directed by the command will be executed; and the work is done.

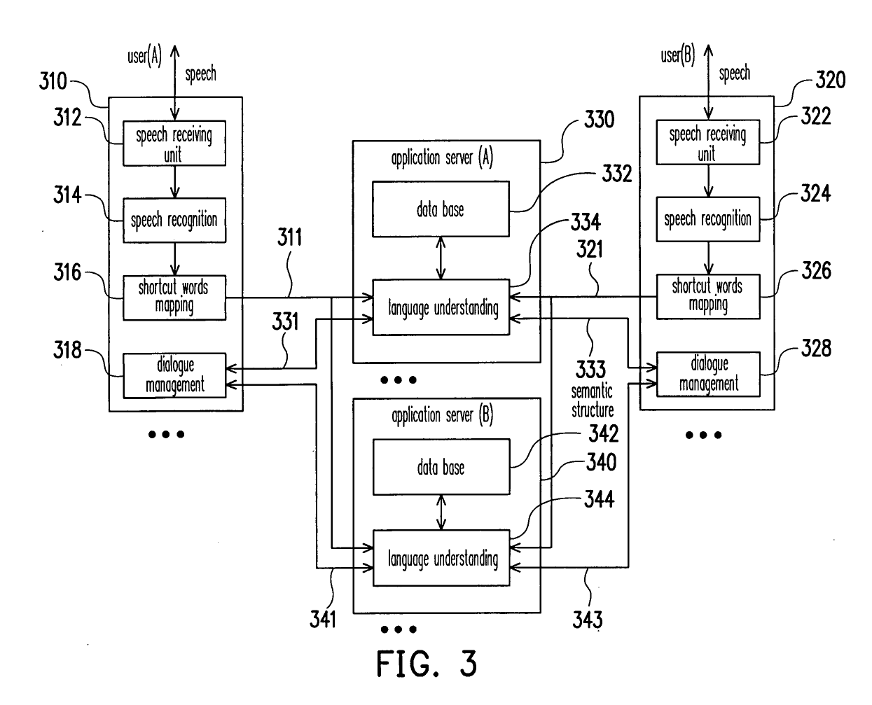

FIG. 3 is a drawing showing a distributed multiple application-dependent language processing unit system architecture with an unified speech recognition function and a unified dialogue interface according to an embodiment of the present invention. In this embodiment, it can be a speech input/dialogue processing interface apparatus. Referring to FIG. 3, the system comprises two speech processing interfaces 310 and 320, and two application servers 330 and 340. The present invention, however, is not limited thereto. The numbers of the speech processing interfaces and the application servers are variable.

The speech processing interface 310 comprises a speech recognition unit 314, a shortcut words mapping unit 316 and a dialogue-management unit 318. In the speech processing interface 310, the sound mode which is speaker-dependent and device dependent is disposed at the local device. The structure enhances the acoustic comparison quality. The speech processing interface 310 receives a speech signal from a user. The speech processing interface 310 may further, as shown in FIG. 3, comprise a speech receiving unit 312, such as a microphone, to conveniently receive the user's speech signal.

Another speech processing interface 320 comprises a speech recognition unit 324, a shortcut words mapping unit 326 and a dialogue-management unit 328. The speech processing interface 320 receives a speech signal from a user. The speech processing interface 320 may further, as shown in FIG. 3, comprise a speech receiving unit 322, such as a microphone, to conveniently receive the user's speech signal. In this embodiment, the speech receiving unit 322 receives the speech signal from the user A.

In the speech processing interface 310, the sound model which is speaker-dependent and device-dependent may be disposed in the speech recognition unit 314. The structure can enhance the acoustic comparison quality. In an embodiment of establishing the sound model which is speaker-dependent and device-dependent, a common model which is speaker-independent and device-independent serves as an initial model. By using the model adaptation technology, the model parameters which are speaker-dependent and device-dependent can be improved, and the recognition accuracy is substantially enhanced, too.

In an embodiment, the lexicon or the N-gram model which is closely related to the speech recognition is applied to the model adaptation technology to improve the recognition accuracy.

In the speech processing interface 310 according to a preferred embodiment of the present invention, according to an output intermediary signal protocol the shortcut words mapping unit 316 performs a mapping comparison of the output from the speech processing interface 310 and the speech recognition result outputted from the speech recognition unit 314. The output result from the speech processing interface 310 is then outputted. Since the back-end processing unit also recognizes the signal according to the output intermediary signal protocol, the speech recognition result is also acceptable, and the semantic recognition accuracy can be maintained. In the output intermediary signal protocol according to a preferred embodiment of the present invention, the signal transmitted from the user usually is a signal composed of common words and sub-words.

In the traditional architecture, various combinations of word groups are used in different application devices. If the unit is a word group, new recognition word groups will be increased continuously due to the increase of the application programs. It will not cause much trouble if there are few application systems. However, if there are many application systems, the amount of the word groups will seriously delay the front-end speech recognition unit. Accordingly, in the embodiment of the present invention, the speech recognition result according to the speech recognition unit 314, after the mapping comparison by the shortcut words mapping unit 316, generates shared signals of common words and of sub-words. Both of the signal sender and the signal receiver can recognize and process the signals defined by the output intermediary signal protocol.

The sub-words described above are fragments smaller than words, such as a Chinese syllable, an English phoneme, multiple English phonemes or an English syllable. The common words comprise frequently used speech commands. The addition of the common words enhances the recognition accuracy, and substantially reduces recognition confusion. The output of the front-end speech recognition can be, for example, an N-Best sequence of common words and sub-words, or a lattice of a common unit as described above.

In the speech processing interface 310, according to the output intermediary signal protocol, the output speech recognition result, after the mapping comparison by the shortcut words mapping unit 316, is transmitted through the signal 311 to a language processing unit to recognize the meaning of the words. For example, the signal 311 is transmitted to the application servers (A) 330 and (B) 340. The signal 311 is a sequence signal or a lattice signal in accordance with the output intermediary signal protocol. The method of transmitting the signal 311 to the application servers (A) 330 and (B) 340 may be, for example, a broadcasting method, a method through a cable communication network or a method through a wireless communication network. It is received by different application analysis devices, or even is transmitted to analysis devices of the same apparatus without through network.

Referring to FIG. 3, the application server (A) 330 comprises a database 332 and a language understanding unit 334. The application server (B) 340 comprises a database 342 and a language understanding unit 334. When the application servers (A) 330 and (B) 340 receive the signal 311, each of them performs the language analysis and processing through its own language understanding unit 334 or 344. By referring to the database 332 or 342, the meaning of the words can be obtained.

Regarding another speech processing interface 320, according to the output intermediary signal protocol, the output speech recognition result, after the mapping comparison by the shortcut words mapping unit 326, is transmitted through the signal 321 to the application servers (A) 330 and (B) 340. The signal 321 is a sequence signal or a lattice signal in accordance with the output intermediary signal protocol. When the application servers (A) 330 and (B) 340 receive the signal 311, each of them performs the language analysis and processing through its own language understanding unit 334 or 344. By referring to the database 332 or 342, the meaning of the words can be obtained.

Different language understanding units correspond to different application systems. As a result, they include different lexica and grammars. These language understanding processing steps screen out unrecognizable intermediary signals (including some common words and sub-words) and maintain recognizable signals so as to analyze the sentence structures and perform the grammar comparison. Then the best and most reliable semantic signal is outputted. The signals output from the language analysis and processing by the language understanding units 334 and 344 are transmitted to the speech processing unit 310 through the semantic signals 331 and 341, or to the speech processing unit 320 through the semantic signals 333 and 343, respectively.

Then, the dialogue-management unit of the speech input/dialogue processing interface apparatus, such as the dialogue-management unit 318 of the speech processing interface 310, or the dialogue-management unit 328 of the speech processing interface 320, collects all transmitted semantic signals. By adding the context semantic signal, the optimized result is determined. Multiple modalities would then be used to respond to the user to complete a dialogue during the conversation. If it is determined as a speech command, and if the confidence index is sufficient, the subsequent action directed by the command is executed; and the work is done.

In the distributed multiple application-dependent language processing unit system with the unified speech recognition function and the unified dialogue interface according to a preferred embodiment of the present invention, all devices for dialogue are disposed at different locations and communicate with or among each other through different transmission interfaces, such as a broadcast station, a cable communication network or a wireless communication network. The signal is received by different application analysis devices or transmitted to analysis devices of the same apparatus without through network.

Regarding a system architecture of an embodiment, it can be a distributed architecture. For example, the local user terminal, such as the speech processing interfaces 310 and 320 include the functions of processing speech recognition and the dialogue management. The language understanding units serving the language understanding and analysis function can be disposed at the back-end of the system application server, i.e., the language understanding unit 334 of the application server (A) 330 or the language understanding unit 344 of the application server (B) 340.

In an embodiment of the present invention, the language understanding unit for the language understanding and analysis function can be disposed at the local user terminal. It depends on the design requirement and the processing calculation capability of the apparatus at the local user terminal. For example, in a weather information search system, the data processing requires a great amount of calculations and storage capacity. Accordingly, many operational processors are necessary to calculate and process these data. The grammar of the data which need to be compared is also more complicated. Thus, the application system analyzing the meaning of the sentences should be located at the remote terminal, i.e., the application server terminal. If the application system comprises many peculiar words or word groups that are different from those in other application systems, it makes sense to perform such process at the application server terminal. Moreover, the application server terminal further collects the lexicon and sentence structures used by different users so as to provide self-learning to the system of the application server terminal. Information, such as personal phone directory, which is usually maintained at the local user terminal, should be processed by the language understanding unit of the local terminal.

Take the example of light control of a conference room. Usually, a processor with calculation function will not be disposed at a light set. The light control, however, can be executed by transmitting a wireless command thereto after the local language understanding unit has been processed. It is also possible that by using a small chip, a limited amount of lexicon, such as “turn on”, “turn off”, “turn the light on”, or “turn the light off”, can be processed therein. Each of the application system terminal and the user interface terminal comprises multiple-to-multiple channels. Different users can use voice to control the light or to search the weather forecast.

In an embodiment, the present invention provides the distributed multiple application-dependent language processing unit system with the unified speech recognition function and the unified dialogue interface. The user's custom of dialogues can be improved through learning. For example, greeting words used in the speech input interface varies with users, and they can still be accurately recognized. The switch commands of the application system used to change operation or dialogue can be personally adjusted so as to accurately switch applications. In another embodiment, based on personal use, nick commands are also available to provide more fun and convenience to users. Some forgettable names of applications can be given personalized names. All of these functions can be provided by the unified speech input interface.

The traditional voice message application system usually comprises a speech recognizer and a language analyzer which are speaker-independent. Usually, the speech recognizer covers most of calculations. A system can handle limited phone channels. If more phone channels are going to be processed, the costs will dramatically increase. Since the channels transmitting voices occupy more resource of hardware, it will result in the bottleneck of the service at the peak time and an increase of the communication fee. If the speech recognition can be processed at the local user terminal in advance, the saving of communication cost can be achieved by only transmitting intermediary signals (including common words and sub-words) with any data transmission routes. The delay of data transmission is suppressed, and the communication costs are reduced. Without performing speech processing at the server terminal, the costs of the operation sources of the server terminal are saved.

The structure not only suffices the speech recognition accuracy, but also saves lots of costs. The unified interface also reduces the troubles resulting from adding or reducing the application devices. Thus, the present invention provides more potential area for speech technology development. With advance of development of central processing units (CPUs), CPUs with a great amount of calculations adapted for hand-held apparatus are also developed. With these techniques, more convenient and long expected human-machine interfaces are just around the corner.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A distributed language processing system, comprising:
a speech input interface, receiving a speech signal;
a speech recognition interface, according to the speech signal received, recognizing and then generating a speech recognition result;
a language processing unit, receiving and analyzing the speech recognition result to generate a semantic signal; and
a dialogue-management unit, receiving and determining the semantic signal, and then generating a semantic information corresponding to the speech signal.

2. The distributed language processing system of claim 1, wherein the speech recognition interface comprises a model adaptation function so that a sound model recognizes the speech signal through the model adaptation function.

3. The distributed language processing system of claim 1, further comprising a mapping unit between the speech recognition interface and the language processing unit, to receive and map the speech recognition result; according to an output intermediary signal protocol, to generate and transmit a mapping signal serving as the speech recognition result to the language processing unit.

4. The distributed language processing system of claim 3, wherein a method of transmitting the mapping signal to the language processing unit comprises a broadcast method.

5. The distributed language processing system of claim 3, wherein a method of transmitting the mapping signal to the language processing unit comprises a method through a cable communication network.

6. The distributed language processing system of claim 3, wherein a method of transmitting the mapping signal to the language processing unit comprises a method through a wireless communication network.

7. The distributed language processing system of claim 3, wherein in the output intermediary signal protocol the mapping signal is formed of a plurality of word units and a plurality of sub-word units.

8. The distributed language processing system of claim 7, wherein the sub-word unit comprises a Chinese syllable.

9. The distributed language processing system of claim 8, wherein the sub-word unit comprises an English phoneme.

10. The distributed language processing system of claim 8, wherein the sub-word unit comprises a plurality of English phonemes.

11. The distributed language processing system of claim 8, wherein the sub-word unit comprises an English syllable.

12. The distributed language processing system of claim 3, wherein the mapping signal is a sequence composed of word units and sub-word units.

13. The distributed language processing system of claim 3, wherein the mapping signal is a lattice composed of a plurality of word units and a plurality of sub-word units.

14. The distributed language processing system of claim 1, wherein if the semantic information corresponding to the speech signal generated from the dialogue-management unit is a speech command, an action corresponding to the speech command is performed.

15. The distributed language processing system of claim 14, wherein if the semantic information corresponding to the speech signal generated from the dialogue-management unit is the speech command, it is determined whether the speech command is larger than a confident command; if so, the action corresponding to the speech command is performed.

16. The distributed language processing system of claim 1, wherein the language processing unit comprises a language understanding unit and a data base, the language understanding unit receives and then analyzes the speech recognition result, and refers to the database to obtain the semantic signal corresponding to the speech recognition result.

17. The distributed language processing system of claim 1, wherein the system is structured according to a distributed architecture; in the distributed architecture, the speech input interface, the speech recognition interface and the dialogue-management unit are at a user terminal; and the language processing unit is at a system application server terminal.

18. The distributed language processing system of claim 17, wherein each system application server terminal comprises a language processing unit corresponding thereto, the language processing unit receives and analyzes the speech recognition result to obtain and transmit the semantic signal to the dialogue-management unit of a speech input/dialog processing interface apparatus; and according to semantic signal from the system application server terminal, a multiple analysis is performed.

19. The distributed language processing system of claim 1, wherein according to a distributed architecture, the speech input interface, the speech recognition interface, the language processing unit and the dialogue-management unit are at a user terminal, and the language processing unit is at a system application server terminal.

20. The distributed language processing system of claim 1, wherein the speech recognition interface enhances recognition efficiency by learning according to a user's dialogue custom.

21. The distributed language processing system of claim 1, wherein the speech input interface comprises a greeting control mechanism, and a greeting of the speech input interface can be changed by a user.

22. The distributed language processing system of claim 2, wherein in the model adaptation function, the sound model, which is speaker-dependent and device-dependent, refers to a common model, which is speaker-independent and device-independent as an initial model parameter to adjust a parameter of the sound model.

23. The distributed language processing system of claim 2, wherein the model adaptation function comprises using a lexicon as a basis for adaptation.

24. The distributed language processing system of claim 2, wherein the model adaptation function comprises an N-gram as a basis for adaptation.

25. A distributed language processing system, comprising:
a speech input interface, receiving a speech signal;
a speech recognition interface, according to the speech signal received, recognizing and then generating a speech recognition result;
a plurality of language processing units, receiving and analyzing the speech recognition result to generate a plurality of semantic signals; and
a dialogue-management unit, receiving and determining the semantic signals, and then generating a semantic information corresponding to the speech signal.

26. The distributed language processing system of claim 25, further comprising a mapping unit between the speech recognition interface and the language processing unit to receive and map the speech recognition result; according to an output intermediary signal protocol, to generate and transmit a mapping signal serving as the speech recognition result to the language processing unit.

27. The distributed language processing system of claim 25, wherein if the semantic information corresponding to the speech signal generated from the dialogue-management unit is a speech command, an action corresponding to the speech command is performed.

28. The distributed language processing system of claim 27, wherein if the semantic information corresponding to the speech signal generated from the dialogue-management unit is the speech command, it is determined whether the speech command is larger than a confident command; if so, the action corresponding to the speech command is performed.

29. The distributed language processing system of claim 25, wherein the language processing unit comprises a language understanding unit and a database, the language understanding unit receives and then analyzes the speech recognition result, and refers to the database to obtain the semantic signal corresponding to the speech recognition result.

30. The distributed language processing system of claim 25, wherein the system is structured according to a distributed architecture; in the distributed architecture, the speech input interface, the speech recognition interface and the dialogue-management unit are at a user terminal; and the language processing unit is at a system application server terminal.

31. The distributed language processing system of claim 30, wherein each system application server terminal comprises a language processing unit corresponding thereto; the language processing unit receives and analyzes the speech recognition result to obtain and transmit the semantic signal to the dialogue-management unit of a speech input/dialog processing interface apparatus; and according to semantic signal from the system application server terminal, a multiple analysis is performed.

32. The distributed language processing system of claim 25, wherein the speech recognition interface enhances recognition efficiency by learning according to a user's dialogue custom.

33. The distributed language processing system of claim 25, wherein the speech input interface comprises a greeting control mechanism, and a greeting of the speech input interface can be changed by a user.

34. A method of outputting a intermediary signal, the method using an output intermediary signal protocol and being adapted for a distributed language processing system; wherein the distributed language processing system is structured with a distributed architecture; the distributed architecture comprises a user terminal and a system application server terminal; the user terminal comprises a speech recognition interface and a dialogue-management unit; the system application server terminal comprises a language processing unit; and the method of outputting the intermediary signal comprises:
receiving and analyzing a speech signal by the speech recognition interface to generate a speech recognition result;
transforming the speech recognition result into a signal formed by a plurality of word units and a plurality of sub-word units according to the output intermediary signal protocol; and transmitting the signal to the language processing unit for analysis to obtain a semantic signal; and
transmitting the semantic signal to the dialogue-management unit to generate a semantic information corresponding to the speech signal.

35. The method of outputting an intermediary signal of claim 34, wherein the sub-word unit comprises a Chinese syllable.

36. The method of outputting an intermediary signal of claim 34, wherein the sub-word unit comprises an English phoneme.

37. The method of outputting an intermediary signal of claim 34, wherein the sub-word unit comprises a plurality of English phonemes.

38. The method of outputting an intermediary signal of claim 34, wherein the sub-word unit comprises an English syllable.

39. The method of outputting an intermediary signal of claim 34, wherein the mapping signal is a sequence composed of the word units and sub-word units.

40. The method of outputting an intermediary signal of claim 34, wherein the mapping signal is a lattice composed of the word units and sub-word units.
